(19) United States
(12) Patent Application Publication
(10) Pub. No.: US 2025/0283353 A1
(43) Pub. Date: Sep. 11, 2025

(54) ELECTROMECHANICAL LOCKING DEVICE

(71) Applicant: LIMITED LIABILITY COMPANY "ELECTRONIC ACCESS", Sverdlovskaya obl. (RU)

(72) Inventors: Evgenii Aleksandrovich SHUTKIN, Sverdlovskaya obl., g. Ekaterinburg (RU); Leonid Vladimirovich ALEKSEEV, Sverdlovskaya obl., g. Sredneural'sk (RU)

(21) Appl. No.: 18/860,557

(22) PCT Filed: Jul. 6, 2022
(86) PCT No.: PCT/RU2022/000218

§ 371 Date: Oct. 25, 2024

(30) Foreign Application Priority Data
Jun. 30, 2022 (RU) 2022117762

(51) Int. Cl. E05B 47/06; E05B 47/00

(52) U.S. Cl. CPC E05B 47/06; E05B 47/0001; E05B 2047/0037; E05B 2047/0085

(57) ABSTRACT

The invention relates to electromechanical non-volatile locking devices powered by a key battery with an electronic coding of unlock code. The technical result of the invention is to reduce energy costs when opening and closing the lock. An electromechanical locking device comprising an electronic key comprising: a tail section with protrusions, negative and positive contacts; a case wherein the power supply and electronic board for storing the electronic code are located, and a lock comprising: a lock case comprising a front bushing and a stationary inner bushing wherein a rotating lock bushing is located, comprising inlet and end sections, wherein negative and positive contacts of the lock located in the inlet section, and the end section is connected to the locking mechanism of the lock by means of a tang; a coupling mechanism comprising a slider with a return spring, configured to transfer force from the protrusion of the tail section of the key to compress the trigger spring pin when inserting the tail section of the electronic key into the shaft of the stationary inner bushing, and fixing the trigger spring pin using a locking mechanism; a lock opening mechanism comprising an electronic control board configured to identify the electronic code of the electronic key and transmit a control signal to an electromagnet, which is configured to transmit force to the locking mechanism by means of a tang by transmitting force to the end section of the rotating bushing of the lock when turning the electronic key in the inlet section of the rotating bushing of the lock after identifying the electronic code of the electronic key, and the transmission of force to the end section of the rotating bushing of the lock connected to a tang is carried out by moving the pin into the hole of the end section of the rotating bushing of the lock after the action of the electromagnet on the locking mechanism, leading to the release of the trigger spring pin, wherein the slider and the pin are configured to return to their original position due to the accumulated energy of the return spring when removing the tail section of the electronic key from the shaft of the stationary inner bushing.

### PERTINENT ART OF THE INVENTION

The invention relates to electromechanical non-volatile locking devices powered by a key battery with an electronic coding of unlock code.

### BACKGROUND OF THE INVENTION

An electromechanical locking device disclosed in RU 2416013 is known in the prior art. The electromechanical locking device comprising a lock and a key, the lock includes a sleeve, an electronic control unit, which is located inside the sleeve, a tail section and a coupling device equipped with an electric drive, which is located inside the sleeve, wherein the sleeve is rotatably mounted on a lockable first component, the tail section includes an adapter that operates to prevent the lockable second component from moving towards the first component, the control unit receives power from the key and operates to generate an enable signal to actuate a coupling device that releasably couples the sleeve and the tail section when actuated, thereby causing them to be rotatably coupled.

The electromechanical device disclosed above has the following disadvantages:
a lot of power is spent to operate and hold the anchor;
a constant power supply is required to hold it in the open state until the key is turned in the keyway, when it is mechanically locked by means of special latches.

Besides, a combination of an electromechanical cylindrical lock and a key as disclosed in RU 2270309 is known from the prior art. The known combination contains a key for the lock with a mechanical locking code and means for storing an electronic code and for transmitting this electronic code to the lock, a rotary sleeve of the lock, locking means which are enclosed in the lock case and which prevent rotation of the lock sleeve relative to the lock case and which can be turned by means of a key into the releasing position, at least one special locking disk, between which and the key there is no connection that directly transmits mechanical forces, identification and adjustment means for receiving and identifying an electronic code transmitted from the key, and a mateable electrical actuator. When the correct electronic key code is matched, said identification and adjustment means cause activation of said electrical actuator to direct the mating means to its mating position. The mating means comprises a rotatable mating element configured to interact with a guide groove in a special locking disk containing a guide surface, wherein the mating element is configured to act on the guide surface in its mating position and facilitates rotation of the special locking disk when the key is turned in the lock.

The electromechanical cylindrical lock and key combination disclosed above has the following disadvantages:
power is spent twice to transfer the locking mechanism from one stable state to another;
an expensive solution, as it requires the use of subminiature electric motors or a special combination of magnets.

### DISCLOSURE OF THE INVENTION

The object of the invention is to create an electromechanical locking device that has two stable states with the lowest possible power consumption at the lowest cost and can be used in the locking mechanism of electromechanical locks.

The technical result of the invention is to reduce energy costs when opening and closing the lock.

The said technical result is attained owing that an electromechanical locking device comprising an electronic key and a lock contains:

For an electronic key:
a tail section with protrusions, negative and positive contacts;
a case wherein the power supply and electronic board for storing the electronic code are located.

For the lock:
a lock case comprising a front bushing and a stationary inner bushing wherein a rotating lock bushing is located, comprising inlet and end sections, wherein negative and positive contacts of the lock located in the inlet section, and the end section is connected to the locking mechanism of the lock by means of a tang;
a coupling mechanism comprising a slider with a return spring, configured to transfer force from the protrusion of the tail section of the key to compress the trigger spring pin when inserting the tail section of the electronic key into the shaft of the stationary inner bushing, and fixing the trigger spring pin using a locking mechanism;
a lock opening mechanism comprising an electronic control board configured to identify the electronic code of the electronic key and transmit a control signal to an electromagnet, which is configured to transmit force to the locking mechanism by means of a tang by transmitting force to the end section of the rotating bushing of the lock when turning the electronic key in the inlet section of the rotating bushing of the lock after identifying the electronic code of the electronic key, and the transmission of force to the end section of the rotating bushing of the lock connected to a tang is carried out by moving the pin into the hole of the end section of the rotating bushing of the lock after the action of the electromagnet on the locking mechanism, leading to the release of the trigger spring pin, wherein the slider and the pin are configured to return to their original position due to the accumulated energy of the return spring when removing the tail section of the electronic key from the shaft of the stationary inner bushing.

### BRIEF DESCRIPTION OF THE DRAWINGS

The invention will become clearer from the description that is not restrictive and is provided with reference to the accompanying drawings, which show the following:

FIG. 1 Longitudinal section of an electromechanical cylinder mechanism.

FIG. 2 Image of an electronic key with a single tail.

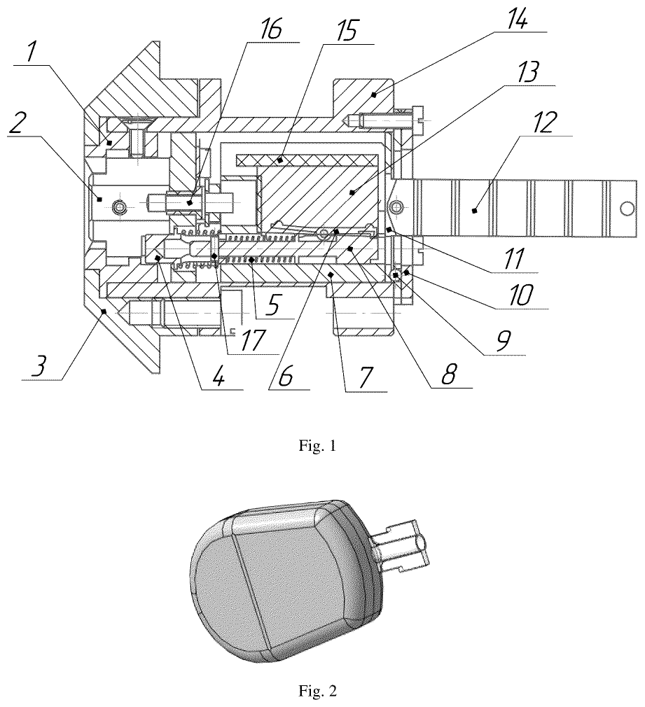

1—stationary inner bushing; 2—inlet section; 3—front bushing; 4—slider; 5—trigger spring; 6—locking mechanism; 7—rotating bushing; 8—pin; 9—ball; 10—separator; 11—end section; 12—tang; 13—electromagnet; 14—case; 15—electronic control board; 16—positive contact, 17 stop pin.

### EMBODIMENT OF THE INVENTION

An electromechanical locking device comprises an electronic key and a lock. The electronic key comprises a tail section with protrusions, negative and positive contacts n a case wherein the power supply and electronic board for storing the electronic code are located.

The lock comprises a case (14), a coupling mechanism and a lock opening mechanism. The lock case (14) comprises a front bushing (3) and a stationary inner bushing (1) wherein a rotating lock bushing (7) is located, comprising inlet (2) and end sections (11), wherein negative and positive contacts (16) of the lock located in the inlet section (2), and the end section (11) is connected to the locking mechanism of the lock by means of a tang (12).

The coupling mechanism comprises a slider (4) with a return spring, configured to transfer force from the protrusion of the tail section of the key to compress the trigger spring (5) pin (8) when inserting the tail section of the electronic key into the shaft of the stationary inner bushing (1), and fixing the trigger spring (5) pin (8) using a locking mechanism (6).

The lock opening mechanism comprising an electronic control board (15) configured to identify the electronic code of the electronic key and transmit a control signal to an electromagnet (13), which is configured to transmit force to the locking mechanism by means of a tang (12) by transmitting force to the end section (11) of the rotating bushing (7) of the lock when turning the electronic key in the inlet section (2) of the rotating bushing (7) of the lock after identifying the electronic code of the electronic key, and the transmission of force to the end section (11) of the rotating bushing (7) of the lock connected to a tang (12) is carried out by moving the pin (8) into the hole of the end section (11) of the rotating bushing (7) of the lock after the action of the electromagnet (13) on the locking mechanism (6), leading to the release of the trigger spring (5) pin (8), wherein the slider (4) and the pin (8) are configured to return to their original position due to the accumulated energy of the return spring when removing the tail section of the electronic key from the shaft of the stationary inner bushing (1).

The claimed electromechanical locking device operates as follows.

The tail section of the electronic key is inserted into the shaft of the stationary inner bushing (1), wherein the protrusions of the tail section of the electronic key are located in the inlet section (2) of the rotating bushing (7) of the lock, and the body of the electronic key comprises a body with dimensions close to a standard car key with a special tail section. After inserting the electronic key into said shaft, the negative and positive contacts in the tail section of the electronic key are closed with the positive (16) and negative power contacts through the metal of the input section (2) of the rotating bushing (7) of the lock for transmitting power and exchanging data between the electronic control board (15) and an electronic key board containing an electronic code.

When the electronic key is inserted into said shaft, the protrusions of the shank couple with the slider (4), resulting in the movement of the slider (4) with a return spring, which in turn compresses the trigger spring (5) transmitting force to the pin (8). The trigger spring (5) pin (8) is held by the locking mechanism (6), thereby cocking the locking mechanism (6) from the force of inserting the electronic key.

After the opposite-polarity contacts of the key are closed with the opposite-polarity contacts of the lock, the electronic key supplies electrical energy to the electronic board (15) of the lock control to open the lock, the electronic board (15) of the lock control determines the authenticity of the command and, if the code hardwired into the electronic board of the key matches, transmits the control pulse signal to the electromagnet (13), which acts on the locking mechanism (6) to release the pin (8). Next, using the energy of the compressed trigger spring (5), the pin moves and enters the hole in the end section (11) to transmit the force from the rotation of the lock bushing (7) to the end section (11). The end section (11) of the rotating bushing (7) of the lock is connected to a tang (12), thereby transmitting the force from the rotation of the electronic key to the locking mechanism. To optimize the activation time of the electromagnet (13) and control the operation of the locking mechanism (6), position sensors of the locking mechanism (6) can be installed. The locations of the end section (11) and the rotating bushing (7) of the lock opposite the pin (8) are synchronized owing to the operation of the separator (10) with balls (9) installed therein, which when falling into specially made recesses in the end section (11) fix its desired position relative to the rotating bushing (7) of the lock.

Owing to the grooves in the shaft, the stationary inner bushing (1) of the lock and the location of the protrusions of the tail section of the electronic key in the inlet section (2) of the rotating bushing (7) of the lock, the electronic key due to the presence of a locking mechanism (6) can be pulled out only in one position of the rotating bushing (7) of the lock, which provides synchronization of the location of the hole in the end section (11) of the rotating bushing (7) of the lock opposite the pin (8).

When removing the tail section of the electronic key from the input section (2) of the rotating bushing (7) of the lock, after turning the electronic key to a position in which it can be pulled out from the shaft of the stationary inner bushing (1) of the lock, the slider (4) is moved by the return spring to its original position, which in turn returns the pin (8) to its original position due to the stop pin (17) of the pin (8), which with its protrusions couples with the groove of the slider (4), while the locking mechanism (6) under the action of a spring of the electromagnet (13) couples into the groove of the pin (8), which ensures the fixation of the pin (8) in its original position. Fixing the pin (8) in its original position provides the return of the locking mechanism to its original state.

Reduced power consumption when opening and closing the lock is achieved by means of the energy from the power source (battery) of the electronic key being spent to transfer force from a miniature low-power electromagnet controlled by an electronic board only to the locking mechanism to decompress the trigger spring. Little energy is spent on actuating the locking mechanism. Approximately about 140 mW for 4—10 milliseconds.

After the locking mechanism has been activated, the lock can remain in the unlocked state for any length of time without consuming energy from the electronic key battery.

The locking mechanism returns to its original position due to the accumulated energy of the return spring when removing the electronic key from the shaft of the stationary inner bushing (1) of the lock, wherein the protrusions of the tail section of the electronic key come out of the inlet section (2) of the rotating bushing (7) of the lock. No battery power is consumed to return the locking mechanism to its original position.

The lever locking mechanism is made such that there is no direct impact of the tail section of the electronic key on the locking mechanism. The locking mechanism is activated only by the electromechanical automatic trigger mechanism.

The invention has been disclosed above with reference to a particular embodiment thereof. For those skilled in the art, other embodiments of the invention not altering its essence may be obvious, as it is disclosed in the present description. Accordingly, the invention should be considered limited in scope only by the following claims.

1. An electromechanical locking device comprising
an electronic key comprising:
a tail section with protrusions, negative and positive contacts;
a case wherein the power supply and electronic board for storing the electronic code are located,
and a lock comprising:
a lock case comprising a front bushing and a stationary inner bushing wherein a rotating lock bushing is located, comprising inlet and end sections, wherein negative and positive contacts of the lock located in the inlet section, and the end section is connected to the locking mechanism of the lock by means of a tang;
a coupling mechanism comprising a slider with a return spring, configured to transfer force from the protrusion of the tail section of the key to compress the trigger spring pin when inserting the tail section of the electronic key into the shaft of the stationary inner bushing, and fixing the trigger spring pin using a locking mechanism;
a lock opening mechanism comprising an electronic control board configured to identify the electronic code of the electronic key and transmit a control signal to an electromagnet, which is configured to transmit force to the locking mechanism by means of a tang by transmitting force to the end section of the rotating bushing of the lock when turning the electronic key in the inlet section of the rotating bushing of the lock after identifying the electronic code of the electronic key, and the transmission of force to the end section of the rotating bushing of the lock connected to a tang is carried out by moving the pin into the hole of the end section of the rotating bushing of the lock after the action of the electromagnet on the locking mechanism, leading to the release of the trigger spring pin, wherein the slider and the pin are configured to return to their original position due to the accumulated energy of the return spring when removing the tail section of the electronic key from the shaft of the stationary inner bushing.
